(19) United States
(12) Patent Application Publication
(10) Pub. No.: US 2025/0085454 A1
(43) Pub. Date: Mar. 13, 2025

(54) SEQUENTIAL RESIDUAL SYMBOLIC REGRESSION FOR MODELING FORMATION EVALUATION AND RESERVOIR FLUID PARAMETERS

(71) Applicant: Halliburton Energy Services, Inc., Houston, TX (US)

(72) Inventors: Christopher Michael JONES, Houston, TX (US); Wei SHAO, Houston, TX (US); Songhua CHEN, Liberty Hill, TX (US)

(73) Assignee: Halliburton Energy Services, Inc., Houston, TX (US)

(21) Appl. No.: 18/243,332

(22) Filed: Sep. 7, 2023

(51) Int. Cl. G01V 99/00

(52) U.S. Cl. CPC G01V 20/00

(57) ABSTRACT

Systems and methods are provided for using sequential residual symbolic regression for petrophysical modeling. An example method can include receiving training data for modeling one or more petrophysical parameters based on reservoir formation data; performing symbolic regression using the training data to obtain a first set of symbolic regression models; determining a first residual based on the training data and a first symbolic regression model from the first set of symbolic regression models; performing symbolic regression using the first residual to obtain a second set of symbolic regression models; and updating the first symbolic regression model based on a second symbolic regression model from the second set of symbolic regression models to yield a first revised symbolic regression model.

### TECHNICAL FIELD

The present disclosure relates generally to wellbore operations and, more specifically (although not necessarily exclusively), to using sequential residual symbolic regression to model formation evaluation (e.g., petrophysical parameters) and reservoir fluid parameters.

### BACKGROUND

Wells can be drilled to access and produce hydrocarbons such as oil and gas from subterranean geological formations. Wellbore operations can include drilling operations, completion operations, fracturing operations, and production operations. Drilling operations may involve gathering information related to downhole geological formations of the wellbore. The information may be collected by wireline logging, logging while drilling (LWD), measurement while drilling (MWD), drill pipe conveyed logging, or coil tubing conveyed logging.

### BRIEF DESCRIPTION OF THE DRAWINGS

The various advantages and features of the present technology will become apparent by reference to specific implementations illustrated in the appended drawings. A person of ordinary skill in the art will understand that these drawings only show some examples of the present technology and would not limit the scope of the present technology to these examples. Furthermore, the skilled artisan will appreciate the principles of the present technology as described and explained with additional specificity and detail through the use of the accompanying drawings in which:

FIG. 1 is a diagram of an illustrative drilling system, in accordance with aspects of the present disclosure;

FIG. 2 is a block diagram of an illustrative system for implementing sequential residual symbolic regression to model formation evaluation and reservoir fluid parameters, in accordance with aspects of the present disclosure;

FIG. 3 is a flowchart of an illustrative process for implementing sequential residual symbolic regression to model formation evaluation and reservoir fluid parameters, in accordance with aspects of the present disclosure;

FIG. 4 is a flowchart of another illustrative process for implementing sequential residual symbolic regression to model formation evaluation and reservoir fluid parameters, in accordance with aspects of the present disclosure; and

FIG. 5 is a block diagram illustrating an example computing device architecture, in accordance with aspects of the present disclosure.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form in order to avoid obscuring the concepts of the subject technology.

Development of a petrophysical interpretation model and/or a fluid property model (e.g., petroleum reservoir fluid, live oil, etc.) for a reservoir rock formation often starts with laboratory analysis of core samples obtained from the formation. In some cases, the results from such a core analysis may be used to determine different sets of petrophysical parameters associated with the formation. The parameters obtained from such core analysis may then be used to estimate rock properties and fluid saturations of the formation.

In some cases, petro-physicists may use machine learning methods (e.g., neural networks) for solving complex physics problems associated with a reservoir rock formation. The machine learning models can be particularly useful if the underlying physics cannot be expressed explicitly and/or is grossly non-linear. For example, machine learning can be useful for integrated petrophysical problems, which involve multiple measurements based on different measuring principles (e.g., NMR, resistivity, GR, acoustic, etc.).

In some other cases, live oil characterization from sampling and testing operations such as downhole pressure-volume-temperature (PVT) tests may also use machine leaning methods to establish fluid property models. Live oil properties, such as gas-oil ratio (GOR) and live oil viscosity, could be affected by fluid density, gas and/or oil compressibility, specific gravity, etc. of the reservoir fluids and the reservoir environmental conditions (e.g., pressure and temperature). The dependency of these parameters with the target live oil parameters are usually non-linear and complex.

However, machine learning models typically have drawbacks in that it is difficult to determine whether the model honors or abides by the underlying physics and/or whether the model is overfitting to noise or bias within the training data. For machine learning models based on petrophysical and/or fluid characterization models with multiple measurements, it may not be clear which measurements have a strong or significant correlation to the predicted petrophysical parameters and/or fluid properties. That is, lack of transparency, expandability, and interpretability hinders the acceptance of machine learning based petrophysical and/or fluid characterization models by many log analysis practitioners.

In some cases, symbolic regression (SR) algorithms can be used to overcome the black box nature of many existing machine learning methods, such as neural networks. For instance, the random feature of a genetic programming-based SR algorithm can provide an unbiased solution. However, SR tends to depend on the termination conditions, data population distribution, allowed random selection. As a result, sometimes the solution equation generated by SR may favor simplicity in function form over the fitting quality, resulting in overly simplified mathematical equations with poor fittings. For example, in cases that involve complex multiphysics measurements (e.g., inputs), the prediction equation performance can be inferior to NN.

The disclosed technology addresses the foregoing by providing systems and techniques for using sequential residual symbolic regression to model petrophysical parameters and/or fluid properties. That is, the present technology can overcome limitation of existing SR algorithms by employing an iterative approach in which a weak SR model is derived by fitting the residual of the previous iteration during each iteration, and the final SR model is an ensemble of the weak SR models. In some cases, the present technology can generate mathematical formulations with a compatible performance with NN models, while keeping the mathematical models in relatively simple forms to prevent overfitting. In some aspects, the output of the symbolic regression algorithm (e.g., the mathematical expression) can illustrate the connection between the logging measurements and the petrophysical parameters and/or the fluid properties. The symbolic regression generated mathematical expression can be examined, evaluated, justified, and/or validated by a user.

In some aspects, symbolic regression can include searching the space of mathematical expressions to fit the training dataset. For instance, symbolic regression may utilize random optimization algorithms, such as Generate Algorithms, to generate a mathematical expression that associates the logging measurement(s) with the petrophysical parameter(s). In some aspects, symbolic regression can be performed iteratively to further refine and/or develop the output expression and improve the performance of the symbolic regression algorithm. That is, sequential residual symbolic regression can be used to generate mathematical models having a performance that is comparable to neural network models and also maintain the mathematical models in a form that is relatively simple to prevent overfitting.

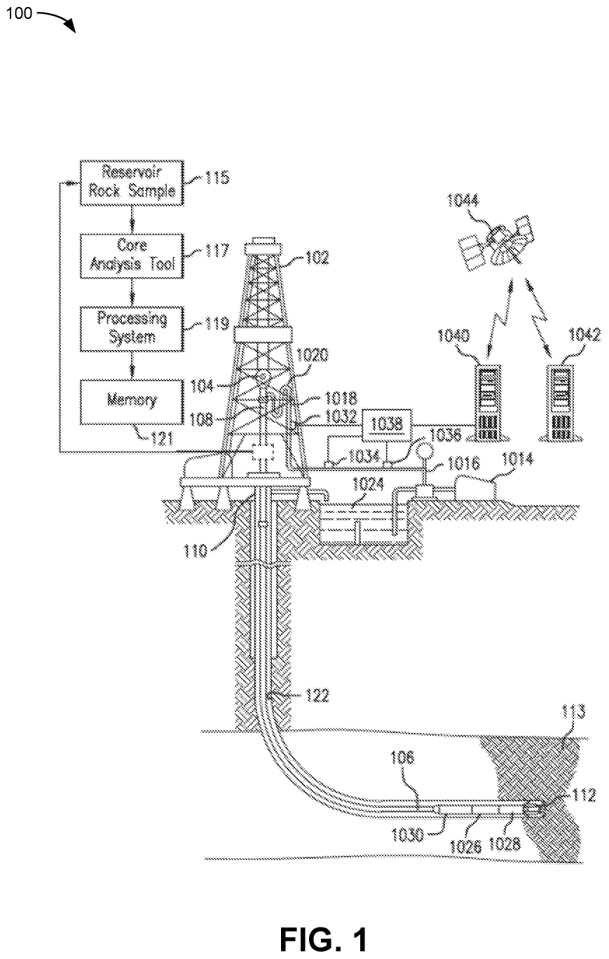

FIG. 1 is a diagram of an illustrative drilling system 100. In accordance with the present disclosure, the drilling system 100 may be used to retrieve a reservoir rock sample, such as a core sample, for characterization of a reservoir. The drilling system 100 may be one in which aspects of the present disclosure may be implemented as part of a downhole operation performed at a well site. For example, the disclosed petrophysical modeling techniques may be performed as part of an overall seismic or other data (e.g., nuclear magnetic resonance (NMR) data) interpretation and well planning workflow for one or more downhole operations at a well site. Such downhole operations may include, but are not limited to, drilling, completion, and injection stimulation operations for recovering petroleum, oil and/or gas, deposits from a hydrocarbon bearing reservoir rock formation. As shown in FIG. 1, drilling system 100 includes a drilling platform equipped with a derrick 102 that supports a hoist 104. Drilling in accordance with some examples is carried out by a string of drill pipes connected together by “tool” joints so as to form a drill string 106. Hoist 104 suspends a top drive 108 that is used to rotate drill string 106 as the hoist lowers the drill string through wellhead 110. Connected to the lower end of drill string 106 is a drill bit 112 for drilling a wellbore 122 through a reservoir formation 113.

In some cases, drill string 106 may also include a reservoir rock sample collection tool (not shown) located near drill bit 112 for retrieving reservoir rock samples as the wellbore 122 is drilled through the formation. The reservoir rock sample collection tool may be designed to retrieve a reservoir rock sample 115 cut from the reservoir formation 113 by drill bit 112 as wellbore 122 is drilled through the formation. It should be appreciated that the reservoir rock sample collection tool may use any suitable mechanism to extract or collect the rock sample 115 from the formation 113. In some examples, the sample 115 may be cut from a side of the wellbore 122 by a separate rock extraction tool included in the reservoir rock sample collection tool and placed in a hollow storage chamber of the collection tool for later retrieval and analysis at the surface of the wellbore.

Further, in some configurations, the collection of rock sample 115 and drilling of the wellbore 122 through rotation of the drill bit 112 may be accomplished by rotating drill string 106. The drill string 106 may be rotated by the top drive 108 or by use of a downhole “mud” motor near the drill bit 112 that independently turns the drill bit 112 or by a combination of both the top drive 108 and a downhole mud motor. During the drilling process, drilling fluid may be pumped by a mud pump 1014 through a flow line 1016, a stand pipe 1018, a goose neck 1020, top drive 108, and down through drill string 106 at high pressures and volumes to emerge through nozzles or jets in drill bit 112. The drilling fluid then travels back up the wellbore 122 via an annulus formed between the exterior of drill string 106 and the wall of wellbore 1022, through a blowout preventer (not specifically shown), and into a mud pit 1024 on the surface. On the surface, the drilling fluid is cleaned and then circulated again by mud pump 1014. The drilling fluid is used to cool drill bit 112, carry cuttings (e.g., including reservoir rock sample 115) from the borehole to the surface, and balance the hydrostatic pressure in the reservoir formation 113.

In some aspects, the reservoir rock sample 115 retrieved from the wellbore 122 and reservoir formation 113 may be a core sample or a plug sample. As described herein, the term core sample may refer to a reservoir rock sample retrieved directly from a wellbore (e.g., wellbore 122) and/or reservoir formation (e.g., formation 113). In some embodiments a core sample may be generally cylindrical in shape and have dimensions (e.g., a diameter and a length) on the order of tens to hundreds of feet. Further, as described herein, the term plug sample may refer to a reservoir rock sample taken from a core sample (e.g., after the core sample is removed from the wellbore 122). In some cases, a plug sample may have a different set of dimensions from the core sample. For instance, a plug sample may have a diameter and/or length on the order of inches or feet. While core samples and plug samples may be described herein as having particular dimensions, it should be appreciated that the present technology is not limited thereto and that a core sample or a plug sample may have any suitable dimensions.

A retrieved reservoir rock sample 115 may be used to characterize certain properties of the reservoir formation 113. In some examples, the retrieved reservoir rock sample 115 may be analyzed to determine a porosity of the reservoir formation 113, a presence of certain minerals within reservoir formation 113, an expected fluid flow within of the reservoir formation 113 and/or the like. In some aspects, such analysis may be performed by physically manipulating (e.g., cutting, coring, and/or the like). Moreover, such analysis may involve the use of a core analysis tool 117, such as a permeameter, to measure or determine the properties of the sample. Additionally or alternatively, images of the reservoir rock sample 115 may be captured using an imaging device, and the resulting image data may be analyzed to determine characteristics of the reservoir formation 113. As an illustrative example, the core analysis tool 117 may be used to perform an imaging scan on the reservoir rock sample 115 to capture image data of the reservoir rock sample. In some configurations, the image data may include a sequence of two-dimensional (2D) images of the reservoir rock sample 115 that may be combined to form a three-dimensional (3D) image of the reservoir rock sample 115. Further, the image data may include a computed tomography (CT) image, a magnetic resonance imaging (MRI) image, an ultrasound image, and/or the like. Accordingly, the core analysis tool 117 may include a suitable imaging device to capture the image data, such as a computed tomography (CT) imaging device, a microCT imaging device, an MRI imaging device, an ultrasound imaging device, and/or the like. However, it should be appreciated that the present technology is not limited thereto and that any of various imaging devices may be used as desired for a particular implementation.

While the reservoir rock sample 115 and core analysis tool 117 are illustrated proximate the drilling system 100, it should be appreciated that the reservoir rock sample 115 may be transported off location for analysis by the core analysis tool 117. In this regard, the core analysis tool 117 may be within a laboratory or at a separate geographical location away from the wellsite. Additionally or alternatively, the core analysis tool 117 may be performed in the field (e.g., proximate to the wellsite).

As further illustrated, the data from the core analysis tool 117 (e.g., the core analysis data produced by the core analysis tool 117) along with other wellsite data may be provided to a processing system 119 (e.g., a computing system). Such other wellsite data may include, for example and without limitation, production data and/or logging data captured by one or more downhole tools, e.g., a logging while drilling (LWD) tool 1026 and/or a measurement while drilling (MWD) tool 1028, coupled to drill string 106, as will be described in further detail below. The processing system 119 may use the disclosed petrophysical modeling techniques described herein to process the data and generate a model of the reservoir formation 113, which can then be used to estimate the formation's rock properties and fluid saturations. In one or more aspects, the processing system 119 may use sequential residual symbolic regression to train a machine learning (ML) model (e.g., a deep neural network) to predict petrophysical properties of the reservoir formation 113 based on the core analysis data and other wellsite data. The processing system 119 may use the trained ML model (also referred to herein as a “symbolic regression model”) to determine properties of the reservoir rock sample 115 and/or the reservoir formation 113.

In some examples, the processing system 119 may be implemented using any type of computing device or system, such as a computer 1040 (described further below), having at least one processor and a memory, such as a memory 121. While processing system 119 and memory 121 are shown separately from each other and separately from computer 1040 in FIG. 1, it should be appreciated that processing system 119 and memory 121 may be separate components that are integrated within computer 1040.

The memory 121 may be any suitable data storage device. Such a data storage device may include any type of recording medium coupled to an integrated circuit that controls access to the recording medium. The recording medium can be, for example and without limitation, a semiconductor memory, a hard disk, or similar type of memory or storage device. In some implementations, memory 121 may be a remote data store, e.g., a cloud-based storage location. The memory 121 may be internal or external to the processing system 119. In some examples, memory 121 may be used to store the core analysis data and/or wellsite data received by the processing system 119, e.g., from the core analysis tool 117 and/or the one or more downhole tools.

In some examples, the one or more downhole tools may be coupled to drill string 106. In the example shown in FIG. 1, such downhole tools may include a LWD tool 1026 and a MWD tool 1028. In one illustrative example, LWD tool 1026 can be used to measure properties of the surrounding formation (e.g., porosity, permeability), and MWD tool 1028 can be used to measure properties associated with wellbore 1022 (e.g., inclination, and direction). Tools 1026 and 1028 may be coupled to a telemetry device 1030 that transmits data (e.g., well-logging data and/or a variety of sensor data) to the surface. Tools 1026 and 1028 along with telemetry device 1030 may be housed within the bottom hole assembly (BHA) attached to a distal end of drill string 106 within the reservoir formation 113. While the tools 1026 and 1028 are described as an LWD tool and a MWD tool, respectively, any suitable downhole tool may be used. To that end, as used herein, the term “downhole tool” may refer to any suitable tool or instrument used to collect information from the wellbore 122. Such a downhole tool may include any of various sensors used to measure different downhole parameters. Such parameters may include logging data related to the various characteristics of the subsurface formation (e.g., resistivity, radiation, density, porosity, etc.), characteristics (e.g., size, shape, etc.) of the wellbore 122 being drilled through the formation, fluid properties (e.g., PVT measurements), and/or characteristics of the drill string 106 (e.g., direction, orientation, azimuth, etc.) disposed within the wellbore 122.

In some instances, telemetry module 1030 may employ any of various communication techniques to send the measurement data collected downhole to the surface. For example, in some cases, telemetry module 1030 may send measurements collected by the downhole tools 1026 and 1028 (or sensors thereof) to the surface using electromagnetic telemetry. In other cases, telemetry module 1030 may send the data by way of electrical or optical conductors embedded in the pipes that make up drill string 106. In yet still other cases, telemetry module 1030 may communicate the downhole measurements by generating pressure pulses that propagate via drilling fluid (e.g., mud) flowing within the drill string 106 at the speed of sound to the surface.

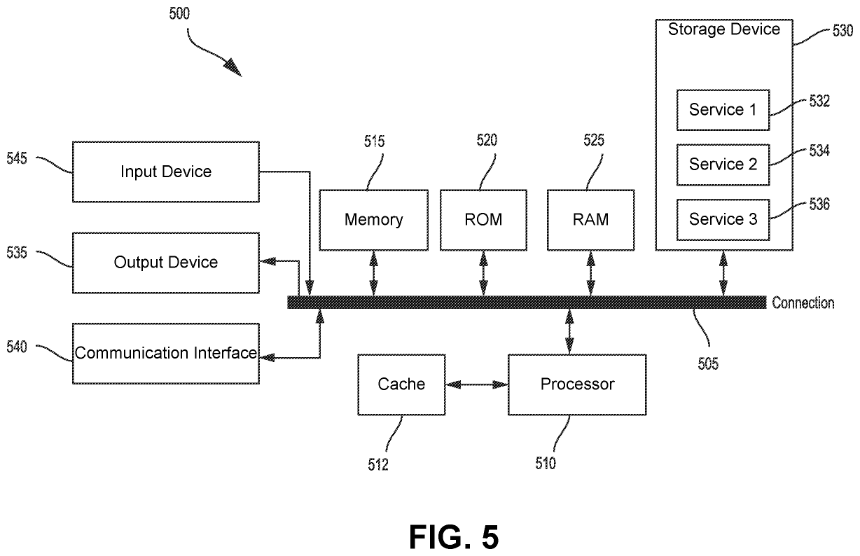

In the mud pulse telemetry example above, one or more transducers, such as transducers 1032, 1034 and/or 1036, may be used to convert the pressure signal into electrical signals for a signal digitizer 1038 (e.g., an analog to digital converter). Additional surface-based sensors (not shown) for collecting additional sensor data (e.g., measurements of drill string rotation (RPM), drilling pressure, mud pit level, etc.) may also be used as desired for a particular implementation. Digitizer 1038 supplies a digital form of the many sensor measurements (e.g., logging data) to computer 1040. Computer 1040 may be implemented using any type of computing device or system, e.g., computing device architecture 500 of FIG. 5, as will be described in further detail below. Computer 1040 operates in accordance with software (which may be stored on a computer-readable storage medium) to process and decode the received signals, and to perform the petrophysical modeling techniques disclosed herein, e.g., for purposes of estimating reservoir rock properties (including fluid saturation) and predicting operational outcomes using drilling system 100.

In some aspects, at least a portion of the wellsite data from the downhole tools 1026 and/or 1028 (e.g., logging data) may be forwarded by computer 1040 via a communication network to another computer system 1042, such as a backend computer system operated by an oilfield services provider, for purposes of remotely monitoring and controlling well site operations and/or performing the disclosed petrophysical modeling techniques. The communication of data between computer system 1040 and computer system 1042 may take any suitable form, such as over the Internet, by way of a local or wide area network, or as illustrated over a satellite 1044 link.

In some cases, computer 1040 may function as a control system for monitoring and controlling downhole operations at the well site. Computer 1040 may be implemented using any type of computing device having at least one processor and a memory. Computer 1040 may process and decode the digital signals received from digitizer 1038 using an appropriate decoding scheme. For example, the digital signals may be in the form of a bit stream including reserved bits that indicate the particular encoding scheme that was used to encode the data downhole. Computer 1040 can use the reserved bits to identify the corresponding decoding scheme to appropriately decode the data. The resulting decoded telemetry data may be further analyzed and processed by computer 1040 to display useful information to a well site operator. For example, a driller could employ computer 1040 to obtain and monitor one or more formation properties of interest before, over the course of, or after a drilling operation. It should be appreciated that computer 1040 may be located at the surface of the well site or at a remote location away from the well site.

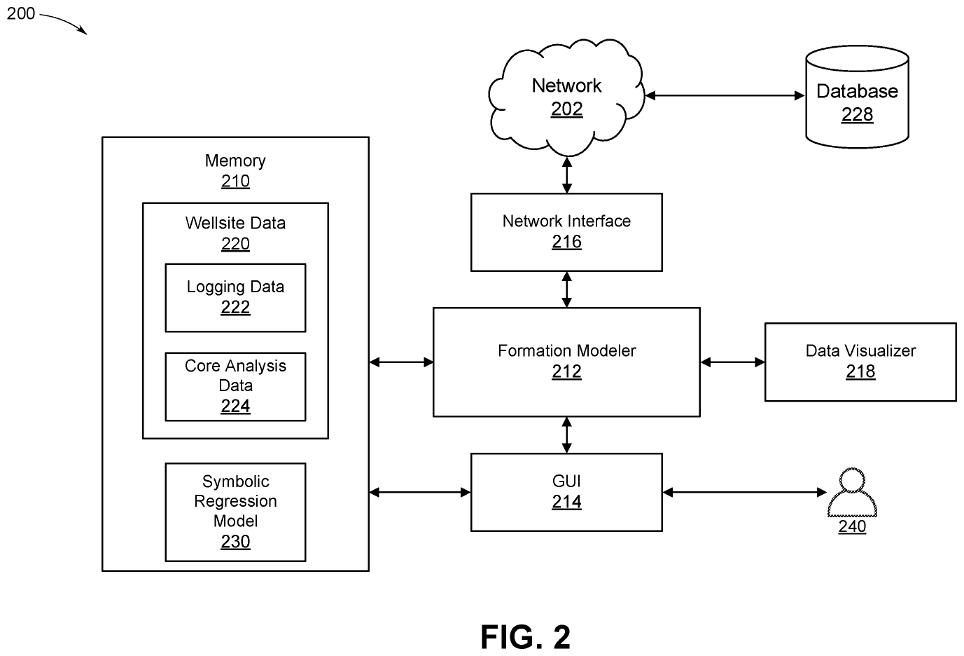

Turning now to FIG. 2, a block diagram of an exemplary system 200 for modeling a reservoir formation and its petrophysical and/or fluid properties using sequential residual symbolic regression is illustrated. As shown in FIG. 2, system 200 includes a memory 210, a formation modeler 212, a graphical user interface (GUI) 214, a network interface 216, and a data visualizer 218. In some cases, memory 210, formation modeler 212, GUI 214, network interface 216, and data visualizer 218 may be communicatively coupled to one another via an internal bus of system 200. Further, in some examples, the components, functions, and/or operations of the system 200 may be included within and/or performed by the processing system 119 and/or the computer 1040 of FIG. 1, as described above.

System 200 may be implemented using any type of computing device having at least one processor and a memory, such as the processing system 119 and/or computer system 1040 of FIG. 1. The memory may be in the form of a processor-readable storage medium for storing data and instructions executable by the processor. Examples of such a computing device include, but are not limited to, a tablet computer, a laptop computer, a desktop computer, a workstation, a mobile phone, a personal digital assistant (PDA), a set-top box, a server, a cluster of computers in a server farm or other type of computing device. In some implementations, system 200 may be a server system located at a data center associated with the hydrocarbon producing field. The data center may be, for example, physically located on or near the field. Alternatively, the data center may be at a remote location away from the hydrocarbon producing field. The computing device may also include an input/output (I/O) interface for receiving user input or commands via a user input device (not shown). The user input device may be, for example and without limitation, a mouse, a QWERTY or T9 keyboard, a touch-screen, a graphics tablet, or a microphone. The I/O interface also may be used by each computing device to output or present information to a user via an output device (not shown). The output device may be, for example, a display coupled to or integrated with the computing device for displaying a digital representation of the information being presented to the user.

Although only memory 210, formation modeler 212, GUI 214, network interface 216, and data visualizer 218 are shown in FIG. 2, it should be appreciated that system 200 may include additional components, modules, and/or sub-components as desired for a particular implementation. It should also be appreciated that memory 210, formation modeler 212, GUI 214, network interface 216, and data visualizer 218, may be implemented in software, firmware, hardware, or any combination thereof. Furthermore, it should be appreciated that memory 210, formation modeler 212, GUI 214, network interface 216, and data visualizer 218, or portions thereof, can be implemented to run on any type of processing device including, but not limited to, a computer, workstation, embedded system, networked device, mobile device, or other type of processor or computer system capable of carrying out the functionality described herein.

As will be described in further detail below, memory 210 can be used to store information accessible by the formation modeler 212 and/or the GUI 214 for implementing the functionality of the present disclosure. While not shown, the memory 210 can additionally or alternatively be accessed by the data visualizer 218 and/or the like. Memory 210 may be any type of recording medium coupled to an integrated circuit that controls access to the recording medium. The recording medium can be, for example and without limitation, a semiconductor memory, a hard disk, or similar type of memory or storage device. In some implementations, memory 210 may be a remote data store, e.g., a cloud-based storage location, communicatively coupled to system 200 over a network 202 via network interface 216 (e.g., a port, a socket, an interface controller, and/or the like). Network 202 can be any type of network or combination of networks used to communicate information between different computing devices. Network 202 can include, but is not limited to, a wired (e.g., Ethernet) or a wireless (e.g., Wi-Fi or mobile telecommunications) network. In addition, network 202 can include, but is not limited to, a local area network, medium area network, and/or wide area network such as the Internet.

In some aspects, memory 210 may be used to store wellsite data 220. Wellsite data 220 may include, for example, logging data 222 (e.g., image logs and/or other logging measurements) and core analysis data 224 associated with a reservoir formation, e.g., formation 113 of FIG. 1, as described above. It should be appreciated, however, that the present technology is not limited thereto and that memory 210 may be used to store other types of data (e.g., production data) associated with the reservoir formation (or one or more wellsites thereof). Such data may have been collected by a variety of different tools. Accordingly, logging data 222 in memory 210 may include data collected by any number of downhole logging tools, and core analysis data 224 may have been collected by any number of core analysis tools. The different tools, e.g., core analyzers and well logging instruments, used to collect this data may be characterized by different measurement physics, which may cause the measurement values obtained for the same set of formation properties to vary depending on the tool that is used. Logging data 222 may include, for example, well logging measurements, e.g., as collected by LWD tool 1026 and MWD tool 1028 of FIG. 1, as described above. Core analysis data 224 may include, for example, NMR, resistivity, induction, acoustic, density, photoelectric (PE) data, spontaneous potential (SP) data, natural gamma ray, neutron, logs, and/or the like, e.g., as obtained from the analysis of a core sample by core analysis tool 117 of FIG. 1, as described above. Logging data 222 may also in include fluid characterization and/or fluid properties such as PVT measurements.

In some configurations, the system 200 may be communicatively coupled to a downhole tool and/or a core analysis tool via network 202. Accordingly, logging data 222 and core analysis tool 224 may be obtained from the downhole tool and the core analysis tool, respectively, over network 202 via network interface 216 of system 200. In some examples, the wellsite data 220 may be obtained from a remote database 228, which may be accessed over network 202 via the network interface 216.

In some cases, the formation modeler 212 may utilize sequential residual symbolic regression (e.g., a symbolic regression (SR) model) and/or machine learning (e.g., an ML model such as a deep neural network) for estimating properties of the reservoir formation (e.g., based on wellsite data 220). In some aspects, the model determined by the trained SR model 230 may be formulated as, for example, a mathematical expression, equation, or function representing the formation's properties. Examples of such formation properties and/or fluid properties include, but are not limited to, Archie's parameters, saturation, formation resistivity factor, GOR, and/or the like. Thus, wellsite data 220, including logging data 222 and core analysis tool 224, in this example may serve as training data for modeling the reservoir formation, e.g., by training SR model 230 to determine an appropriate formation model.

As shown in FIG. 2, SR model 230 may also be stored in memory 210. In one or more examples, the sequential residual symbolic regression used by formation modeler 212 may include a model selection algorithm that is capable of improving a population of candidate models. In some cases, the underlying algorithm of the symbolic regression may mimic genetic evolution processes that consist of iteratively performing crossover and mutation operations. Crossover may involve randomly merging or combining two candidate models into two new candidate models. Mutation may involve making a random change to at least a part of an individual candidate model to create a new candidate model and associated function. The associated function may be, for example, a set of equations or mathematical expressions corresponding to a child population of candidate models. The functions/equations defining the child candidate models may be derived by randomly perturbing or varying one or more parameters of the corresponding functions/equations used to define the models in a parent population. Such parameters may include, for example, one or more coefficients, constants, exponents, etc. of the corresponding function/equation. Iterative mutations and crossovers in the symbolic regression may eventually produce an optimized target function (e.g., a mathematical expression) that defines a corresponding model of the reservoir formation.

As noted above, formation modeler 212 may train SR model 230 using a sequential residual symbolic regression algorithm. That is, after an initial iteration of symbolic regression is performed, formation modeler 212 may calculate the residual by using the training dataset and the symbolic regression model. In some cases, formation modeler 212 can perform a further iteration of symbolic regression using the residual to obtain another symbolic regression model. The initial symbolic regression model may therefore be updated based on the subsequent symbolic regression model. In some cases, formation modeler 212 may repeat this process (e.g., determine residual, perform symbolic regression on residual, and update the model) until the improvement in model performance is less than an expected threshold value and/or until the total number of sequences reaches a predefined number.

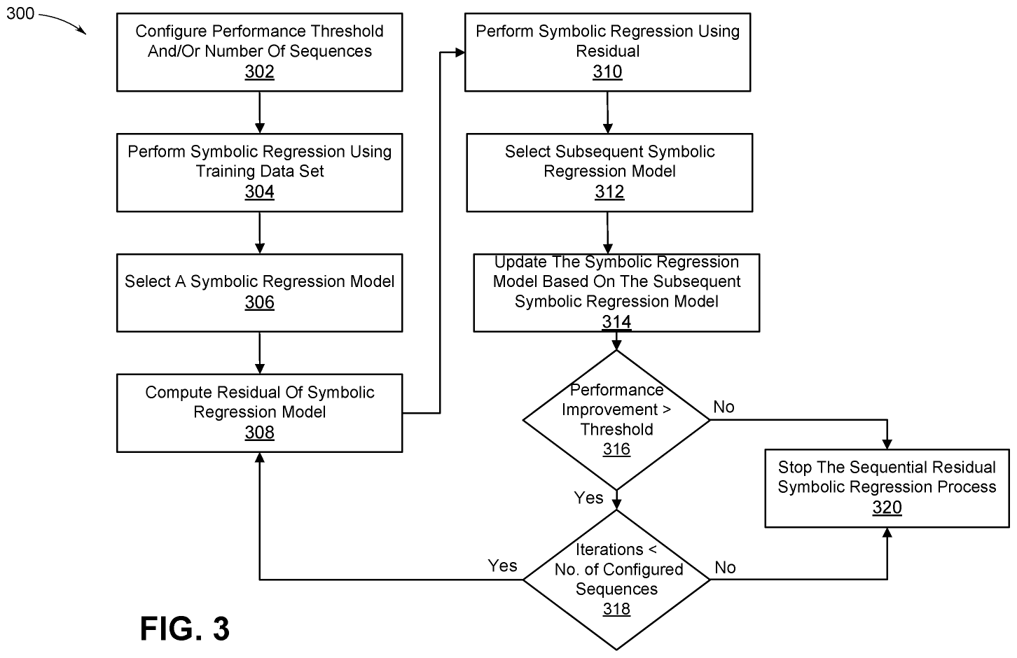

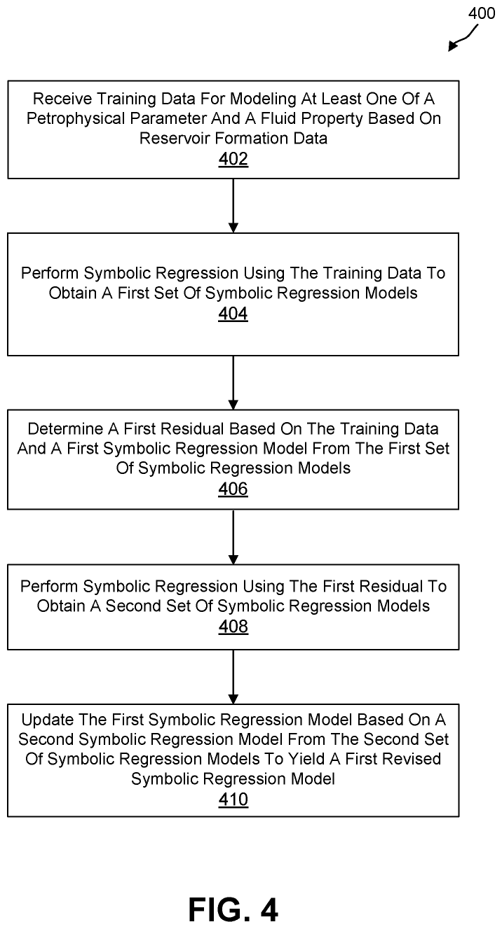

In some examples, the SR model 230 utilized by formation modeler 212 may be trained using a variety of different types of data associated with the reservoir formation, such as wellsite data 220, e.g., from a variety of different data sources (e.g., different logging and/or core analysis tools) to estimate a property of the formation that is not included in the data. For instance, the SR model 230 may be trained to use data collected from various instruments, such as a core analysis tool and a downhole tool (e.g., a logging tool), to identify a candidate model that corresponds to the data from each of the instruments. To that end, the formation modeler 212 may combine measurement data corresponding to different physics to determine a model (e.g., as defined by a mathematical expression) that enables a petrophysics practitioner to evaluate, justify, and validate whether the model is consistent with the various physics of the formation. In that regard, the crossover of input data coming from two different measurement physics, e.g., as performed by the formation modeler 212 using symbolic regression, may integrate different data sets, and the mutation process performed by the formation modeler 212 may produce an optimized model resulting from this integration. Further details regarding the use of sequential residual symbolic regression for training a SR model, such as SR model 230, (also referred to herein as a “symbolic regression model”) to determine an optimal formation model (e.g., as selected from a population of candidate models) and estimate formation properties using such a model will be described in further detail below with respect to FIGS. 3-4.

In some configurations, the property of the formation may be represented by an Archie parameter, such a tortuosity coefficient, a cementation exponent, or a saturation exponent associated with the reservoir formation, as described above. Additionally or alternatively, the property may be a porosity, permeability, capillary pressure, bound fluid volume, shale volume, productivity index, relative permeability, effective permeability, hydrocarbon properties, formation salinity, and/or the like. In some aspects, the property may include a fluid property such as gas-oil ratio. Further, in some cases, the system may further manipulate or use an estimated property to determine a further property.

In some cases, the system 200 may output the estimated property of the reservoir formation (e.g., petrophysical property, fluid property, etc.). In some examples, the property of the reservoir formation may be provided as a numerical indication, a graphical indication, a textual indication, or a combination thereof. For instance, the property of the reservoir formation may output to and/or by the GUI 214, and/or the data visualizer 218. In one illustrative example, the property of the reservoir formation may be output to the GUI 214, which may be provided on a display (e.g., an electronic display). The display may be, for example and without limitation, a cathode ray tube (CRT) monitor, a liquid crystal display (LCD), or a touch-screen display, e.g., in the form of a capacitive touch-screen light emitting diode (LED) display. Further, the data visualizer 218 may be used to generate different data visualizations, such as bar graphs, pie graphs, histograms, plots, charts, numerical indications, textual indications, and/or the like based on the property of the reservoir formation. The data visualizer 218 may further perform any suitable data analysis on the property of the reservoir formation, such as interpolation, extrapolation, averaging, determining a standard deviation, summing or subtracting, multiplying or dividing, and/or the like. Moreover, the data visualizer 218 may be used to visualize a model of the reservoir formation based on the estimated property of the reservoir formation and/or the wellsite data 220 (e.g., logging data 222 and/or core analysis data 224). In some instances, the formation model may be visualized as a 2D or a 3D model within GUI 214.

In some aspects, GUI 214 can enable a user 240 to view and/or interact directly with the modeled reservoir formation or properties thereof. For example, the user 240 may use a user input device (e.g., a mouse, keyboard, microphone, touch-screen, a joy-stick, and/or the like) to interact with the modeled parameters of the reservoir formation via the GUI 214. In some instances, the GUI 214 may receive a user input via such a device to modify, accept, or reject the estimated property of the reservoir formation. Moreover, in some configurations, such a user input may alter the training and/or output of the formation modeler 212, as described in greater detail below. The GUI 214 may additionally or alternatively receive a user input to generate the model, to generate a particular data visualization (e.g., via the data visualizer 218), to run a particular simulation with the model, to adjust a characteristic of the model and/or a data visualization, and/or the like.

While certain components of the system 200 are illustrated as being in communication with one another, the present technology is not limited thereto. To that end, any combination of the components (including memory 210, formation modeler 212, GUI 214, network interface 216, and data visualizer 218) illustrated in FIG. 2 may be communicatively coupled via an internal bus of system 200.

FIG. 3 illustrates an example of a process 300 for implementing sequential residual symbolic regression to model formation evaluation and reservoir fluid parameters. In some aspects, sequential residual symbolic regression can include an iterative process that can be used to search a sequence of symbolic regression models {SRᵢ}ᵢ₌₀^{N} so by fitting the residual of the previous iteration. Although the process 300 depicts a particular sequence of operations, the sequence may be altered without departing from the scope of the present disclosure. For example, some of the operations depicted may be performed in parallel or in a different sequence that does not materially affect the function of process 300. In other examples, different components of an example device or system that implements process 300 may perform functions at substantially the same time or in a specific sequence.

At block 302, the process 300 includes configuring a performance threshold T and/or the total number of sequences N. In some cases, the performance threshold T and the number of sequences N may be configured by a user (e.g., user 240). In one implementation, the performance threshold T may correspond to a desired error threshold (e.g., percentage, range, minimum, maximum, etc.).

At block 304, the process 300 includes performing symbolic regression using a training data set. As noted above, the training data set can include logging data 222 and/or core analysis data 224. Further, symbolic regression can include a model selection algorithm that is capable of improving a population of candidate models. In some cases, the symbolic regression algorithm may mimic genetic evolution processes that consist of iteratively performing crossover and mutation operations. The functions/equations defining the child candidate models may be derived by randomly perturbing or varying one or more parameters of the corresponding functions/equations used to define the models in a parent population.

At block 306, the process 300 includes selecting a symbolic regression model. That is, in some cases, the symbolic regression algorithm may provide multiple outputs (e.g., equations) that could be used to model petrophysical parameters and/or fluid properties. In some examples, an initial symbolic regression model (e.g., SR₀) can be selected based on the model performance meeting the performance threshold T.

At block 308, the process 300 includes computing the residual of the symbolic regression model. In some aspects, computation of the residual can be represented according to Equation (1), as follows:

$${r}_{n} = Y - {SR}^{n - 1} \qquad ( 1 )$$

In Equation (1), Y corresponds to the target values of the training dataset, and SRⁿ⁻¹ is the ensemble of the previous n−1 step SR models. That is, SRⁿ⁻¹ can be represented as follows:

$$S {R}^{n - 1} = {\sum }_{i = 0}^{n - 1} S {R}_{i} \qquad ( 2 )$$

At block 310, the process 300 includes performing symbolic regression using the residual rₙ to obtain the multiple symbolic regression models whose model prediction performances meet the threshold T.

At block 312, the process 300 includes selecting a subsequent symbolic regression model (e.g., after performing symbolic regression using the residual). As noted above, the model can be selected based on the performance threshold T.

At block 314, the process 300 includes updating the symbolic regression model (e.g., based on the subsequent symbolic regression model from block 312). In some examples, the model update can be represented according to Equation (3), as follows:

$$S {R}^{n} = {\sum }_{i = 0}^{n} S {R}_{i} \qquad ( 3 )$$

At block 316, the process 300 can include determining whether the performance improvement (e.g., for consecutive symbolic regression models) is greater than an improvement threshold value. That is, performance of model SRⁿ can be compared to performance of model SRⁿ⁻¹ to determine whether the improvement is greater than an expected value. For example, a threshold performance improvement value can be used to prevent overfitting and/or to limit the time and/or computational resources used in training the model. In some aspects, if the performance improvement is not greater than a threshold value, the process can proceed to block 320 in which the sequential residual symbolic regression process is stopped.

In some examples, if the performance improvement is greater than a threshold value, the process 300 can proceed to step 318 to determine whether the current iteration of the process is less than the number of configured sequences (e.g., configured at block 302). If the number of sequential residual symbolic regression iterations has reached the configured number of sequences, the process 300 can proceed to block 320 in which the sequential residual symbolic regression process is stopped. That is, a pre-defined number of iteration generations can be used to cause a termination condition. However, if the number of iterations is less than the configured number of sequences, the process 300 can return to and repeat the operations of blocks 308-314.

In some aspects, when process 300 is completed, the model can be deployed and used for determining one or more petrophysical parameters and/or fluid properties. Equation (4) below illustrates an example of a symbolic regression model that can be developed using process 300.

$$ln ( GOR ) = \{ \begin{matrix}7.67 + 0.42 ln ( P ) - 6.42 ρ + 0.02 + 1834.98 {c}_{ch 4} + \\ 3.08 {ρ}_{ch 4} - 0.01 {API}^{o} - 1.1 ρ + 3.57 + \frac{37.36}{T} + \\ 77.4 \frac{{ρ}_{ch 4}}{{API}^{o}} - 0.02 {API}^{o} - 3.3 {ρ}_{ch 4} - 4.15 min ( 0.68 , ρ ) + \\ 0.02 + \frac{5.14 e - 9}{8.73 e - 7 + {ρ}_{ch 4} * {c}_{oil} - 8. e - 9 * T}\end{matrix} \qquad ( 4 )$$

The exemplary symbolic regression model from Equation (4) includes four sequences (i.e., each row in Equation (4) corresponds to a sequence). By combining the four sequences, the symbolic regression model can be represented according to Equation (5), as follows:

$$ln ( G O R ) = 11.28 + 0.42 ln ( P ) - 7.52 ρ - 4.15 min ( 0.68 , ρ ) - 0.22 {ρ}_{c h 4} - 0.03 {API}^{o} + \frac{37.36}{T} + 77.40 \frac{{ρ}_{c h 4}}{{API}^{o}} + \frac{5.14 e - 9}{8.73 e - 7 + {ρ}_{c h 4} * {c}_{o i l} - 8. e - 9 * T} \qquad ( 5 )$$

The variables and units of measure that are included in Equation (4) and Equation (5) are as follows: GOR=gas to oil ratio (scf/STB); P=pressure (psi); T=temperature, (C); μₛₐₜ=saturation viscosity (cP); μ_{sat,ens}=saturation viscosity from the ensembled model (cP); c_{CH4}=methane compressibility (1/psi); cₒᵢₗ=oil compressibility (1/psi); cₛₐₜ=saturated fluid compressibility (1/psi); ρ=fluid density (g/cm³); and ρ_{CH4}=methane density (g/cm³).

FIG. 4 illustrates an example of a process 400 for implementing sequential residual symbolic regression to model formation evaluation and reservoir fluid parameters, in accordance with aspects of the present disclosure. Although the process 400 depicts a particular sequence of operations, the sequence may be altered without departing from the scope of the present disclosure. For example, some of the operations depicted may be performed in parallel or in a different sequence that does not materially affect the function of process 400. In other examples, different components of an example device or system that implements process 400 may perform functions at substantially the same time or in a specific sequence.

At block 402, the process 400 includes receiving training data for modeling at least one of a petrophysical parameter and a fluid property based on reservoir formation data. For example, formation modeler 212 can receive training data (e.g., logging data 222, core analysis data 224, etc.) for modeling one or more petrophysical parameters and/or fluid properties based on reservoir formation data. In some cases, the reservoir formation data can include at least one of nuclear magnetic resonance (NMR) data, resistivity data, induction data, acoustic data, density data, photoelectric (PE) data, spontaneous potential (SP) data, natural gamma ray data, pressure data, temperature data, volume data, and neutron data. In some aspects, the one or more petrophysical parameters can include at least one of permeability, porosity, saturation, capillary pressure, bound fluid volume, shale volume, rock saturation, productivity index, relative permeability, effective permeability, hydrocarbon properties, formation salinity, and gas-oil ratio. In some examples, the training data can include customized reservoir formation data obtained from a reservoir formation surrounding a wellbore drilled within the reservoir formation.

At block 404, the process 400 includes performing symbolic regression using the training data to obtain a first set of symbolic regression models. For instance, formation modeler 212 can perform symbolic regression using the training data to obtain a first set of symbolic regression models (e.g., symbolic regression model 230).

At block 406, the process 400 includes determining a first residual based on the training data and a first symbolic regression model from the first set of symbolic regression models. For example, formation modeler 212 can determine a first residual based on the training data and a first symbolic regression model from the first set of symbolic regression models. That is, in some implementations, formation modeler 212 can determine the residual based on Equation (1). In some examples, the process 400 can include selecting the first symbolic regression model from the first set of symbolic regression models based on a threshold performance parameter. For example, formation modeler can select a regression model that satisfies performance threshold T.

At block 408, the process 400 includes performing symbolic regression using the first residual to obtain a second set of symbolic regression models. For example, formation modeler 212 can perform symbolic regression using the first residual.

At block 410, the process 400 includes updating the first symbolic regression model based on a second symbolic regression model from the second set of symbolic regression models to yield a first revised symbolic regression model. For instance, formation modeler 212 can update the symbolic regression model based on the output (e.g., model, equation, etc.) that is determined by performing symbolic regression on the residual. In some cases, formation modeler 212 can update the symbolic regression model according to Equation (3).

In some examples, the process 400 can include determining a second residual based on the training data and the second symbolic regression model; performing symbolic regression using the second residual to obtain a third set of symbolic regression models; and updating the first revised symbolic regression model based on a third symbolic regression model from the third set of symbolic regression models to yield a second revised symbolic regression model. For example, formation modeler 212 can perform steps 308-314 of process 300 to iteratively develop and update the symbolic regression model.

In some aspects, the process 400 can include determining a performance delta between the first revised symbolic regression model and the second revised symbolic regression model. For instance, formation modeler 212 can determine the performance of a first symbolic regression model and a second symbolic regression model in order to determine whether the incremental improvement is greater than an expected performance improvement.

In some examples, the process 400 can include selecting the second revised symbolic regression model as a final symbolic regression model in response to the performance delta being less than a threshold improvement value. That is, if the incremental improvement in performance is less than an expected threshold, formation modeler 212 can terminate the iterative process and select the last updated regression model as the finalized model.

In some instances, the process 400 can include determining that the performance delta is greater than a threshold improvement value, and in response, determine a third residual based on the training data the third symbolic regression model; perform symbolic regression using the third residual to obtain a fourth set of symbolic regression models; and update the second revised symbolic regression model based on a fourth symbolic regression model from the fourth set of symbolic regression models to yield a third revised symbolic regression model. That is, formation modeler 212 can repeat steps 308-314 of process 300 in response to determining that the performance delta (e.g., performance improvement) is greater than a threshold value.

In some configurations, the process 400 can include receiving at least one logging sensor measurement associated with a reservoir formation; and estimating, based on the first revised symbolic regression model, at least one of the one or more petrophysical parameters for the reservoir formation. For instance, once the iterative process of sequential residual symbolic regression is complete, SR model 230 can be deployed and used to determine petrophysical parameters based on logging sensor measurements.

FIG. 5 illustrates an example computing device architecture 500 which can be employed to perform various steps, methods, and techniques disclosed herein. Specifically, the techniques described herein can be implemented, at least in part, through the computing device architecture 500 in an applicable computing device, such computing device 126 and/or downhole tool 118. The various implementations will be apparent to those of ordinary skill in the art when practicing the present technology. Persons of ordinary skill in the art will also readily appreciate that other system implementations or examples are possible.

As noted above, FIG. 5 illustrates an example computing device architecture 500 of a computing device which can implement the various technologies and techniques described herein. The components of the computing device architecture 500 are shown in electrical communication with each other using a connection 505, such as a bus. The example computing device architecture 500 includes a processing unit (CPU or processor) 510 and a computing device connection 505 that couples various computing device components including the computing device memory 515, such as read only memory (ROM) 520 and random access memory (RAM) 525, to the processor 510.

The computing device architecture 500 can include a cache of high-speed memory connected directly with, in close proximity to, or integrated as part of the processor 510. The computing device architecture 500 can copy data from the memory 515 and/or the storage device 530 to the cache 512 for quick access by the processor 510. In this way, the cache can provide a performance boost that avoids processor 510 delays while waiting for data. These and other modules can control or be configured to control the processor 510 to perform various actions. Other computing device memory 515 may be available for use as well. The memory 515 can include multiple different types of memory with different performance characteristics. The processor 510 can include any general purpose processor and a hardware or software service, such as service 1 532, service 2 534, and service 3 536 stored in storage device 530, configured to control the processor 510 as well as a special-purpose processor where software instructions are incorporated into the processor design. The processor 510 may be a self-contained system, containing multiple cores or processors, a bus, memory controller, cache, etc. A multi-core processor may be symmetric or asymmetric.

To enable user interaction with the computing device architecture 500, an input device 545 can represent any number of input mechanisms, such as a microphone for speech, a touch-sensitive screen for gesture or graphical input, keyboard, mouse, motion input, speech and so forth. An output device 535 can also be one or more of a number of output mechanisms known to those of skill in the art, such as a display, projector, television, speaker device, etc. In some instances, multimodal computing devices can enable a user to provide multiple types of input to communicate with the computing device architecture 500. The communications interface 540 can generally govern and manage the user input and computing device output. There is no restriction on operating on any particular hardware arrangement and therefore the basic features here may easily be substituted for improved hardware or firmware arrangements as they are developed.

Storage device 530 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 525, read only memory (ROM) 520, and hybrids thereof. The storage device 530 can include services 532, 534, 536 for controlling the processor 510. Other hardware or software modules are contemplated. The storage device 530 can be connected to the computing device connection 505. In one aspect, a hardware module that performs a particular function can include the software component stored in a computer-readable medium in connection with the necessary hardware components, such as the processor 510, connection 505, output device 535, and so forth, to carry out the function.

For clarity of explanation, in some instances the present technology may be presented as including individual functional blocks including functional blocks comprising devices, device components, steps or routines in a method embodied in software, or combinations of hardware and software.

In some examples the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can include hardware, firmware and/or software, and can take any of a variety of form factors. Typical examples of such form factors include laptops, smart phones, small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific examples thereof, but those skilled in the art will recognize that the application is not limited thereto. Thus, while illustrative examples of the application have been described in detail herein, it is to be understood that the disclosed concepts may be otherwise variously embodied and employed, and that the appended claims are intended to be construed to include such variations, except as limited by the prior art. Various features and aspects of the above-described subject matter may be used individually or jointly. Further, examples can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate examples, the methods may be performed in a different order than that described.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The various illustrative logical blocks, modules, circuits, and algorithm steps described in connection with the examples disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the method, algorithms, and/or operations described above. The computer-readable data storage medium may form part of a computer program product, which may include packaging materials.

The computer-readable medium may include memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

Other aspects of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

In the above description, terms such as “upper,” “upward,” “lower,” “downward,” “above,” “below,” “downhole,” “uphole,” “longitudinal,” “lateral,” and the like, as used herein, shall mean in relation to the bottom or furthest extent of the surrounding wellbore even though the wellbore or portions of it may be deviated or horizontal. Correspondingly, the transverse, axial, lateral, longitudinal, radial, etc., orientations shall mean orientations relative to the orientation of the wellbore or tool.

The term “coupled” is defined as connected, whether directly or indirectly through intervening components, and is not necessarily limited to physical connections. The connection can be such that the objects are permanently connected or releasably connected. The term “outside” refers to a region that is beyond the outermost confines of a physical object. The term “inside” indicates that at least a portion of a region is partially contained within a boundary formed by the object. The term “substantially” is defined to be essentially conforming to the particular dimension, shape or another word that substantially modifies, such that the component need not be exact. For example, substantially cylindrical means that the object resembles a cylinder, but can have one or more deviations from a true cylinder.

The term “radially” means substantially in a direction along a radius of the object, or having a directional component in a direction along a radius of the object, even if the object is not exactly circular or cylindrical. The term “axially” means substantially along a direction of the axis of the object. If not specified, the term axially is such that it refers to the longer axis of the object.

Although a variety of information was used to explain aspects within the scope of the appended claims, no limitation of the claims should be implied based on particular features or arrangements, as one of ordinary skill would be able to derive a wide variety of implementations. Further and although some subject matter may have been described in language specific to structural features and/or method steps, it is to be understood that the subject matter defined in the appended claims is not necessarily limited to these described features or acts. Such functionality can be distributed differently or performed in components other than those identified herein. The described features and steps are disclosed as possible components of systems and methods within the scope of the appended claims.

Moreover, claim language reciting “at least one of” a set indicates that one member of the set or multiple members of the set satisfy the claim. For example, claim language reciting “at least one of A and B” means A, B, or A and B.

### Statements of the Disclosure Include:

Statement 1. A method comprising: receiving training data for modeling at least one of a petrophysical parameter and a fluid property based on reservoir formation data; performing symbolic regression using the training data to obtain a first set of symbolic regression models; determining a first residual based on the training data and a first symbolic regression model from the first set of symbolic regression models; performing symbolic regression using the first residual to obtain a second set of symbolic regression models; and updating the first symbolic regression model based on a second symbolic regression model from the second set of symbolic regression models to yield a first revised symbolic regression model.

Statement 2. The method of Statement 1, further comprising: determining a second residual based on the training data and the second symbolic regression model; performing symbolic regression using the second residual to obtain a third set of symbolic regression models; and updating the first revised symbolic regression model based on a third symbolic regression model from the third set of symbolic regression models to yield a second revised symbolic regression model.

Statement 3. The method of Statement 2, further comprising: determining a performance delta between the first revised symbolic regression model and the second revised symbolic regression model.

Statement 4. The method of Statement 3, further comprising: selecting the second revised symbolic regression model as a final symbolic regression model in response to the performance delta being less than a threshold improvement value.

Statement 5. The method of any of Statements 3 to 4, further comprising: in response to determining that the performance delta is greater than a threshold improvement value: determining a third residual based on the training data and the third symbolic regression model; performing symbolic regression using the third residual to obtain a fourth set of symbolic regression models; and updating the second revised symbolic regression model based on a fourth symbolic regression model from the fourth set of symbolic regression models to yield a third revised symbolic regression model.

Statement 6. The method of any of Statements 1 to 5, further comprising: selecting the first symbolic regression model from the first set of symbolic regression models based on a threshold performance parameter.

Statement 7. The method of any of Statements 1 to 6, further comprising: receiving at least one logging sensor measurement associated with a reservoir formation; and estimating, based on the first revised symbolic regression model, at least one of the petrophysical parameter and the fluid property for the reservoir formation.

Statement 8. The method of any of Statements 1 to 7, wherein the at least one of the petrophysical parameter and the fluid property include at least one of permeability, porosity, saturation, capillary pressure, bound fluid volume, shale volume, rock saturation, productivity index, relative permeability, effective permeability, hydrocarbon properties, formation salinity and gas-oil ratio.

Statement 9. The method of any of Statements 1 to 8, wherein the reservoir formation data include at least one of nuclear magnetic resonance (NMR) data, resistivity data, induction data, acoustic data, density data, photoelectric (PE) data, spontaneous potential (SP) data, natural gamma ray data, neutron data, volume data, temperature data, and pressure data.

Statement 10. The method of any of Statements 1 to 9, wherein the training data includes customized reservoir formation data obtained from a reservoir formation surrounding a wellbore drilled within the reservoir formation.

Statement 11. An apparatus comprising: at least one memory; and at least one processor coupled to the at least one memory, wherein the at least one processor is configured to perform operations in accordance with any one of Statements 1 to 10.

Statement 12. An apparatus comprising means for performing operations in accordance with any one of Statements 1 to 10.

Statements 13. A non-transitory computer-readable medium comprising instructions that, when executed by an apparatus, cause the apparatus to perform operations in accordance with any one of Statements 1 to 10.

What is claimed is:

1. A system comprising:
a memory; and
one or more processors coupled to the memory, the one or more processors being configured to:
receive training data for modeling at least one of a petrophysical parameter and a fluid property based on reservoir formation data;
perform symbolic regression using the training data to obtain a first set of symbolic regression models;
determine a first residual based on the training data and a first symbolic regression model from the first set of symbolic regression models;
perform symbolic regression using the first residual to obtain a second set of symbolic regression models; and
update the first symbolic regression model based on a second symbolic regression model from the second set of symbolic regression models to yield a first revised symbolic regression model.

2. The system of claim 1, wherein the one or more processors are further configured to:
determine a second residual based on the training data and the second symbolic regression model;
perform symbolic regression using the second residual to obtain a third set of symbolic regression models; and
update the first revised symbolic regression model based on a third symbolic regression model from the third set of symbolic regression models to yield a second revised symbolic regression model.

3. The system of claim 2, wherein the one or more processors are further configured to:
determine a performance delta between the first revised symbolic regression model and the second revised symbolic regression model.

4. The system of claim 3, wherein the one or more processors are further configured to:
select the second revised symbolic regression model as a final symbolic regression model in response to the performance delta being less than a threshold improvement value.

5. The system of claim 3, wherein the one or more processors are further configured to:
determine that the performance delta is greater than a threshold improvement value and in response:
determine a third residual based on the training data and the third symbolic regression model;
perform symbolic regression using the third residual to obtain a fourth set of symbolic regression models; and
update the second revised symbolic regression model based on a fourth symbolic regression model from the fourth set of symbolic regression models to yield a third revised symbolic regression model.

6. The system of claim 1, wherein the one or more processors are further configured to:
select the first symbolic regression model from the first set of symbolic regression models based on a threshold performance parameter.

7. The system of claim 1, wherein the one or more processors are further configured to:
receive at least one logging sensor measurement associated with a reservoir formation; and
estimate, based on the first revised symbolic regression model, at least one of the petrophysical parameter and the fluid property for the reservoir formation.

8. The system of claim 1, wherein the at least one of the petrophysical parameter and the fluid property include at least one of permeability, porosity, saturation, capillary pressure, bound fluid volume, shale volume, rock saturation, productivity index, relative permeability, effective permeability, hydrocarbon properties, formation salinity and gas-oil ratio.

9. The system of claim 1, wherein the reservoir formation data include at least one of nuclear magnetic resonance (NMR) data, resistivity data, induction data, acoustic data, density data, photoelectric (PE) data, spontaneous potential (SP) data, natural gamma ray data, neutron data, volume data, temperature data, and pressure data.

10. The system of claim 1, wherein the training data includes customized reservoir formation data obtained from a reservoir formation surrounding a wellbore drilled within the reservoir formation.

11. A computer-implemented method comprising:
receiving training data for modeling at least one of a petrophysical parameter and a fluid property based on reservoir formation data;
performing symbolic regression using the training data to obtain a first set of symbolic regression models;
determining a first residual based on the training data and a first symbolic regression model from the first set of symbolic regression models;
performing symbolic regression using the first residual to obtain a second set of symbolic regression models; and
updating the first symbolic regression model based on a second symbolic regression model from the second set of symbolic regression models to yield a first revised symbolic regression model.

12. The computer-implemented method of claim 11, further comprising:
determining a second residual based on the training data and the second symbolic regression model;
performing symbolic regression using the second residual to obtain a third set of symbolic regression models; and
updating the first revised symbolic regression model based on a third symbolic regression model from the third set of symbolic regression models to yield a second revised symbolic regression model.

13. The computer-implemented method of claim 12, further comprising:
determining a performance delta between the first revised symbolic regression model and the second revised symbolic regression model.

14. The computer-implemented method of claim 13, further comprising:
selecting the second revised symbolic regression model as a final symbolic regression model in response to the performance delta being less than a threshold improvement value.

15. The computer-implemented method of claim 13, further comprising:
in response to determining that the performance delta is greater than a threshold improvement value:
determining a third residual based on the training data and the third symbolic regression model;
performing symbolic regression using the third residual to obtain a fourth set of symbolic regression models; and
updating the second revised symbolic regression model based on a fourth symbolic regression model from the fourth set of symbolic regression models to yield a third revised symbolic regression model.

16. The computer-implemented method of claim 11, further comprising:
selecting the first symbolic regression model from the first set of symbolic regression models based on a threshold performance parameter.

17. The computer-implemented method of claim 11, further comprising:
receiving at least one logging sensor measurement associated with a reservoir formation; and
estimating, based on the first revised symbolic regression model, at least one of the petrophysical parameter and the fluid property for the reservoir formation.

18. The computer-implemented method of claim 11, wherein the at least one of the petrophysical parameter and the fluid property include at least one of permeability, porosity, saturation, capillary pressure, bound fluid volume, shale volume, rock saturation, productivity index, relative permeability, effective permeability, hydrocarbon properties, formation salinity, and gas-oil ratio, and wherein the reservoir formation data include at least one of nuclear magnetic resonance (NMR) data, resistivity data, induction data, acoustic data, density data, photoelectric (PE) data, spontaneous potential (SP) data, natural gamma ray data, neutron data, volume data, temperature data, and pressure data.

19. The computer-implemented method of claim 11, wherein the training data includes customized reservoir formation data obtained from a reservoir formation surrounding a wellbore drilled within the reservoir formation.

20. A non-transitory computer-readable medium having instructions stored thereon which, when executed by a computer or processor, cause the computer or the processor to:
receive training data for modeling at least one of a petrophysical parameter and a fluid property based on reservoir formation data;
perform symbolic regression using the training data to obtain a first set of symbolic regression models;
determine a first residual based on the training data and a first symbolic regression model from the first set of symbolic regression models;
perform symbolic regression using the first residual to obtain a second set of symbolic regression models; and
update the first symbolic regression model based on a second symbolic regression model from the second set of symbolic regression models to yield a first revised symbolic regression model.
